(19) United States
(12) Patent Application Publication
(10) Pub. No.: US 2017/0155166 A1
(43) Pub. Date: Jun. 1, 2017

(54) COMPOSITE LITHIUM SECONDARY BATTERY

(71) Applicant: ENERGY CONTROL LIMITED, Tortola (VG)

(72) Inventor: Donald P. H. WU, HSINCHU COUNTY (TW)

(73) Assignee: ENERGY CONTROL LIMITED

(21) Appl. No.: 14/955,867

(22) Filed: Dec. 1, 2015

(51) Int. Cl. H01M 10/04; H01M 4/525; H01M 10/0525; H01M 4/583; H01M 4/58; H01M 4/505

(52) U.S. Cl. CPC H01M 10/0431; H01M 4/5825; H01M 4/505; H01M 10/0525; H01M 4/583; H01M 4/525; H01M 2220/30

(57) ABSTRACT

A composite lithium secondary battery, and the core assembly of the secondary battery includes: at least one positive electrode layer, at least one negative electrode layer and a plurality of separating layers which are superimposed one another and rolled up to form the core assembly. The positive electrode layer is provided with a plurality of coating sections and at least one non-coating section. The coating sections are coated with different positive electrode materials which are separated from one another by the non-coating section. At least one coating section on each of the two opposite surfaces of the positive electrode layer is coated with a different positive electrode material than other coating sections. The positive electrode materials are LFP and lithium-containing ternary oxides, so that, during the process of charge and discharge, the lithium secondary battery would have the advantages of different positive electrode materials.

### BACKGROUND OF THE INVENTION

Field of the Invention

The present invention relates to a secondary lithium battery, and more particularly to a composite lithium secondary battery whose positive electrode is coated with different positive electrode materials.

Related Prior Art

In recent years, portable electronic devices, such as video camera, digital still camera, mobile phone, and notebook computer, have been widely used. In order to make the electronic devices easy to carry and have a prolonged working time, how to reduce the size and weight of the battery while extending the service life thereof has become the main technical problem that has to be solved. Therefore, lightweight secondary batteries with high energy density have been developed and used as power source of the portable electronic devices.

The charge and discharge in lithium secondary battery occurs by the process of intercalation and deintercalation of lithium ions. The lithium secondary battery has been widely used due to it provides higher energy density than the lead battery and Ni-Cd battery do. As shown in FIGS. 1A and 1B, the existing lithium secondary battery A includes positive and negative electrode layers and a separating layer disposed therebetween. The positive and negative electrode layers and the separating layer roll up into a core assembly A1, and the core assembly A1 is then put into a housing A2 of a circular battery (as shown in FIG. 1A) or a rectangular battery (as shown in FIG. 1. B). The lithium secondary battery includes electrolyte, positive electrode and negative electrode. The positive electrode is formed by coating a positive plate with positive electrode active material, the negative electrode is formed by coating a negative plate with negative electrode active material, and the electrolyte is a dissolvent containing electorate. The positive and negative electrode materials are most important factors to improve the capacitance density of the lithium secondary battery.

As for the negative electrode material, the change in the crystal structure of the carbon material is very small during the process of intercalation and deintercalation of lithium ions, therefore, currently, carbon material, such as graphite, has been widely adopted as negative electrode material, in order to enhance the property, such as capacitance of the lithium battery. The positive electrode materials normally used in lithium battery includes LiCoO₂, LiNiO₂, LiMn₂O₄, LiMnO₂, LiNiCoMnO₂, LNCM, LiNixCoyAl_{1-x-y}O₂, LNCAk, LiFePO₄, LFP.

It should be noted that the current positive electrode is made by casting a both lateral surfaces of a positive plate with a single positive electrode material. However, different positive electrode materials have respective merits and faults. For example, LiMn₂O₄ has a low capacitance but a high thermal safety, therefore, it is suitable for use in medium and large high power battery. LiFePO₄ has a higher thermal safety than LiMn₂O₄, and has no risk of explosion or overheat, therefore it is suitable for use in large high power battery. The lithium secondary battery with a single type of positive electrode material only can have good performance in some of the characteristics.

The present invention has arisen to mitigate and/or obviate the afore-described disadvantages.

### SUMMARY

The present invention is aimed at providing a composite lithium secondary battery with a positive electrode which is provided with a plurality of coating sections, and the coating sections are coated with different positive electrode materials which are selected from the group consisting of LFP (LiMₓPO₄) and lithium-containing ternary oxides, so that, during the process of charge and discharge, the lithium secondary battery would have the advantages of different positive electrode materials, so as to provide a composite lithium secondary battery with high voltage, high capacitance and high safety.

To achieve the above objective, a composite lithium secondary battery in accordance with the present invention comprises a core assembly, and the core assembly comprises: at least one positive electrode layer, at least one negative electrode layer and a plurality of separating layers disposed between the positive and negative electrode layers, wherein the positive and negative electrode layers and the separating layer are superimposed one another and then roll up to form the core assembly. The positive electrode layer is provided with positive electrode materials which allow for intercalation and deintercalation of electrode reaction material, at least one positive electrode ear is provided at a lateral edge of the positive electrode layer, two opposite surfaces of the positive electrode layer are provided with the positive electrode materials, when the positive electrode layer rolls up into a coil, one of two opposite ends of the positive electrode layer which is located in a center of the coil is defined as an inner end, and another of the two opposite ends is defined as an outer end, the negative electrode layer being provided with negative electrode materials which allow for intercalation and deintercalation of the electrode reaction material. At least one negative electrode ear is provided at a lateral edge of the negative electrode layer. Each of the two opposite surfaces is provided with a plurality of coating sections and at least one non-coating section, each of the coating sections is coated with one of the positive electrode materials, and the positive electrode materials coated on the two opposite surfaces of the positive electrode layer are located in alignment with each other, the coating sections and the positive electrode materials coated thereon are separated from one another by the non-coating section, a width D of the non-coating section is larger than 0.5 mm, at least one said coating section on each of the two opposite surfaces of the positive electrode layer is coated with a different positive electrode material than other coating sections, the positive electrode materials include a combination of LiFePO₄ and lithium-containing ternary oxide.

Preferably, the lithium-containing ternary oxide is selected from a group consisting of LiNiₓCoyAl_{1-x-y}O₂ or LiNiCoMnO₂, or a combination of LiFePO₄ and LiNiₓCoyAl_{1-x-y}O₂. The composite lithium secondary battery with LFP+LNCA has a working voltage ranging from 4.5 V to 2.7 V, and a capacitance over 175 mAh/g. The composite lithium secondary battery with LFP+LNCA has a working voltage ranging from 4.4 V to 2.6 V, and a capacitance over 185 mAh/g.

Preferably, the width of the non-coating section is smaller than 5 cm and larger than 0.5 mm.

Preferably, the negative electrode materials include carbon materials of graphite or coke.

Preferably, one of the coating sections which is closest to the outer end of the positive electrode layer is LiFePO₄.

Preferably, a non-coating section connected between two opposite lateral edges of the positive electrode layer is defined as a longitudinal non-coating section, a non-coating section connected between the inner and outer ends of the positive electrode layer is defined as a transverse non-coating section, a non-coating section connected between the two opposite lateral edges or the inner and outer ends in an inclined manner is defined as an inclined non-coating section, the longitudinal non-coating section, the transverse non-coating section or the inclined non-coating section is formed on each of the two opposite surfaces to divide the two opposite surfaces of the positive electrode layer into the plurality of coating sections.

### BRIEF DESCRIPTION OF THE DRAWINGS

FIG. 1A is a perspective view showing that a core assembly of a conventional lithium secondary battery is in a circular battery housing;

FIG. 1B is a perspective view showing that a core assembly of a conventional lithium secondary battery is in a rectangular battery housing;

FIG. 2 is an exploded view of a core assembly of a composite lithium secondary battery in accordance with the present invention;

FIG. 3A is a front view showing the coating of positive electrode materials on the composite lithium secondary battery in accordance with the first embodiment of the present invention;

FIG. 3B is a bottom view showing the coating of positive electrode materials on the composite lithium secondary battery in accordance with the first embodiment of the present invention;

FIG. 4A is a front view showing the coating of positive electrode materials on the composite lithium secondary battery in accordance with the second embodiment of the present invention;

FIG. 4B is a bottom view showing the coating of positive electrode materials on the composite lithium secondary battery in accordance with the second embodiment of the present invention;

FIG. 4C is a side view showing the coating of positive electrode materials on the composite lithium secondary battery in accordance with the second embodiment of the present invention;

FIG. 5A is a front view showing the coating of positive electrode materials on the composite lithium secondary battery in accordance with the third embodiment of the present invention;

FIG. 5B is a side view showing the coating of positive electrode materials on the composite lithium secondary battery in accordance with the third embodiment of the present invention;

FIG. 6A is a front view showing the coating of positive electrode materials on the composite lithium secondary battery in accordance with the fourth embodiment of the present invention;

FIG. 6B is a side view showing the coating of positive electrode materials on the composite lithium secondary battery in accordance with the fourth embodiment of the present invention;

FIG. 6C is a bottom view showing the coating of positive electrode materials on the composite lithium secondary battery in accordance with the fourth embodiment of the present invention;

FIG. 7 shows the characteristic curves of the composite lithium secondary battery (LFP+LNCA) and the lithium secondary battery with a single positive electrode material (LFP, LNCA); and

FIG. 8 shows the characteristic curves of the composite lithium secondary battery (LFP+LNCM) and the lithium secondary battery with a single positive electrode material (LFP, LNCM).

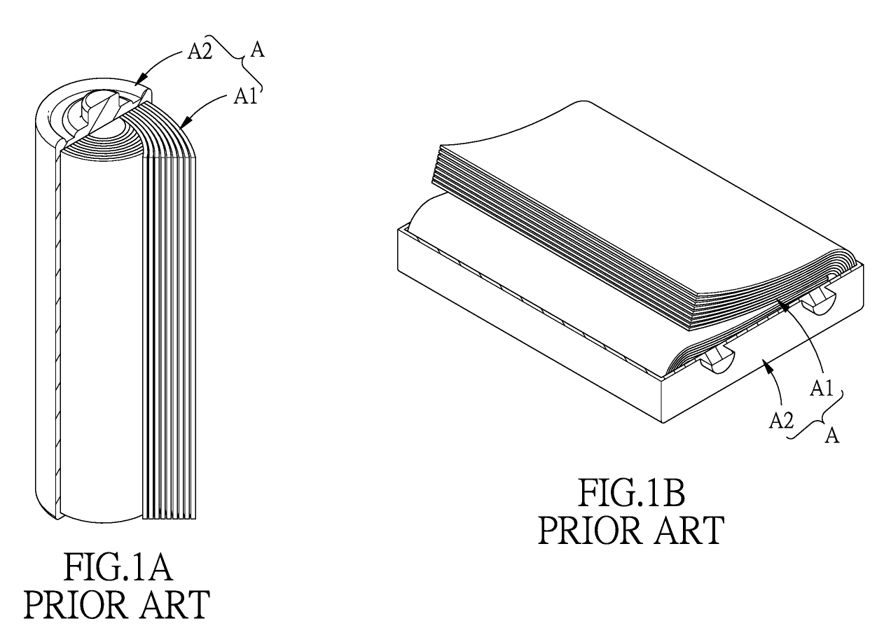

### DETAILED DESCRIPTION

The present invention will be clearer from the following description when viewed together with the accompanying drawings, which show, for purpose of illustrations only, the preferred embodiment in accordance with the present invention.

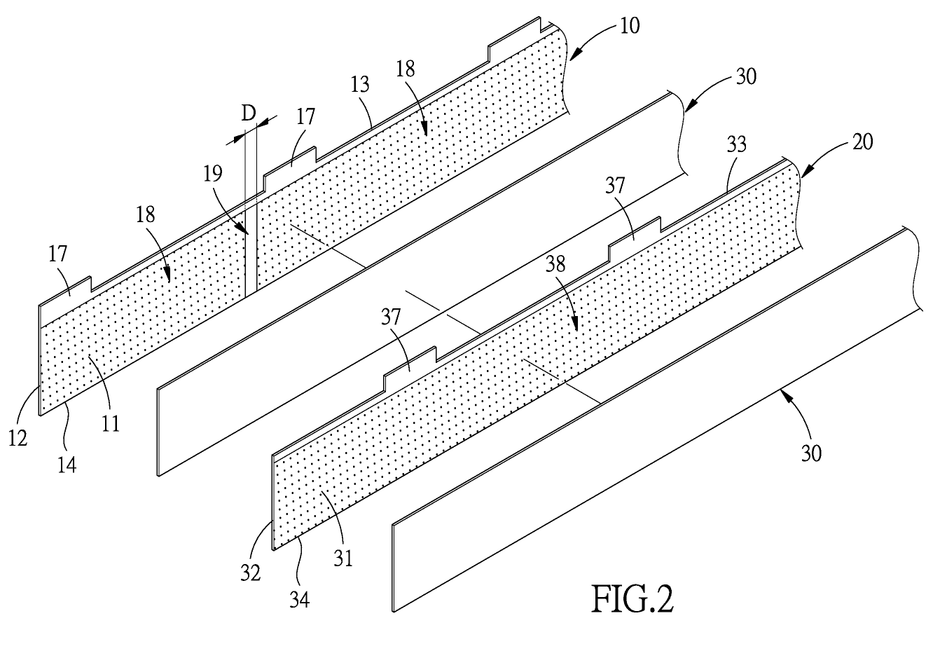

Referring to FIGS. 2 and 3A-6C, a composite lithium secondary battery in accordance with the preferred embodiment of the present invention is shown, wherein a core assembly of the composite lithium secondary battery comprises: at least one positive electrode layer 10, at least one negative electrode layer 20 and a plurality of separating layers 30 disposed between the positive and negative electrode layers 10, 20. The positive and negative electrode layers 10, 20 and the separating layer 30 are superimposed one another and then roll up into the core assembly, and then the core assembly is put into a housing to form a composite lithium secondary battery. In this embodiment, as shown in FIG. 2, the core assembly includes a positive electrode layer 10, an inner separating layer 30, a negative electrode layer 20 and an outer separating layer 30 which are assembled together to form an electrode assembly, and the number of the electrode assembly can be increased based on the capacitance requirement.

As shown in FIG. 2, the positive electrode layer 10 includes two opposite surfaces 11, 12. Between the two opposite surfaces 11, 12 are defined two opposite lateral edges 13, 14 and two opposite ends which are shorter than the two opposite lateral edges 13, 14. When the positive electrode layer 10 rolls up into a coil, one of the two opposite ends located in the center of the coil is defined as an inner end 15, and another of the two opposite ends is defined as an outer end 16. The lateral edge 13 is provided with at least one positive electrode ear 17. Each of the two opposite surfaces 11, 12 is provided with a coating area which allows for coating of electrode reaction material for intercalation and deintercalation of positive electrode material, such as lithium ion. Each of the coating areas includes a plurality of coating sections 18 and at least one non-coating section 19. Each of the coating sections 18 is coated with positive electrode material, and the positive electrode materials coated on the two opposite surfaces 11, 12 of the positive electrode layer 10 are located in alignment with each other. The coating sections 18 and the positive electrode materials coated thereon are separated from one another by the non-coating section 19. At least one coating section 18 on each of the two opposite surfaces 11, 12 of the positive electrode layer 10 is coated with a different positive electrode material than other coating sections 18.

In this embodiment, the non-coating section 19 is in the shape of an elongated strip disposed between the coating sections 18 to prevent accumulation of the positive electrode material in the overlapped area, which otherwise will increase the thickness of the coating, the electrodes cannot be flatly superimposed one another, and would adversely affect the discharge efficiency. A width D of the non-coating section 19 is larger than 0.5 mm (D≧5 mm), and can be smaller than 5 cm but larger than 0.5 mm (5 cm≧D≧0.5 mm) based on the design of the battery to meet different demands.

The positive electrode material of the composite lithium secondary battery of the present invention is the combination of LFP (LiFePO₄) and lithium-containing ternary oxide. The lithium-containing ternary oxide is preferably chosen from the group consisting of LNCA (LiNiₓCoyAl_{1-x-y}O₂) and LNCM (LiNiCoMnO₂), so as to form the combination of (LFP+LNCA) or (LFP+LNCM).

The positive electrode layer 10 is formed by coating an aluminum substrate (such as aluminum foil) with positive electrode material. The positive electrode material can also includes conductive agent and adhesive agent which are used to apply the active substance formed by the lithium containing oxide to the aluminum substrate. The adhesive agent includes but is limited to resin adhesive.

The negative electrode layer 20 includes two opposite surfaces 21, 22. Between the two opposite surfaces 21, 22 are defined two opposite lateral edges 23, 24 and two opposite ends which are shorter than the two opposite lateral edges 23, 24. When the negative electrode layer 20 rolls up into a coil, one of the two opposite ends located in the center of the coil is defined as an inner end 25, and another of the two opposite ends is defined as an outer end 26. The lateral edge 23 is provided with at least one negative electrode ear 27. Each of the two opposite surface 21, 22 is provided with a coating area which allows for intercalation and deintercalation of negative electrode material of the electrode reaction material, such as lithium ion.

The negative electrode material of the composite lithium secondary battery of the present invention is selected from the carbon material of graphite or coke. More specifically, the negative electrode layer 20 is formed by coating a copper substrate (such as copper foil) with the negative electrode material. The negative electrode material can also include conductive agent and adhesive agent which are used to apply the carbon material to the copper substrate. The adhesive agent includes but is limited to resin adhesive. Besides, the separating layer 30 is a microporous or porous film which is used to close or block passage and separate the positive and negative electrode layers 10, 20, and the material of the separating layer 30 includes but is not limited to PP or PE.

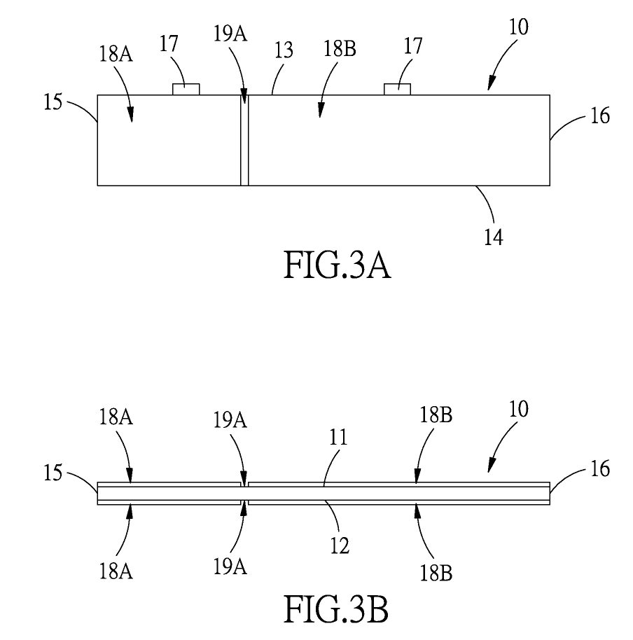

What mentioned above are the structure and material of the positive electrode layer 10, the negative electrode layer 20 and the separating layer 30 of the preferred embodiment of the present invention, and for the coating area of the positive electrode layer 10, please refer to FIGS. 3A-6C. The positive electrode material applied to the coating area is preferably the lithium-containing ternary oxide the combination of LFP and LNCA or LNCM. Besides, the positive electrode material applied to the coating section 18 which is closest to the outer end 16 is preferably LFP.

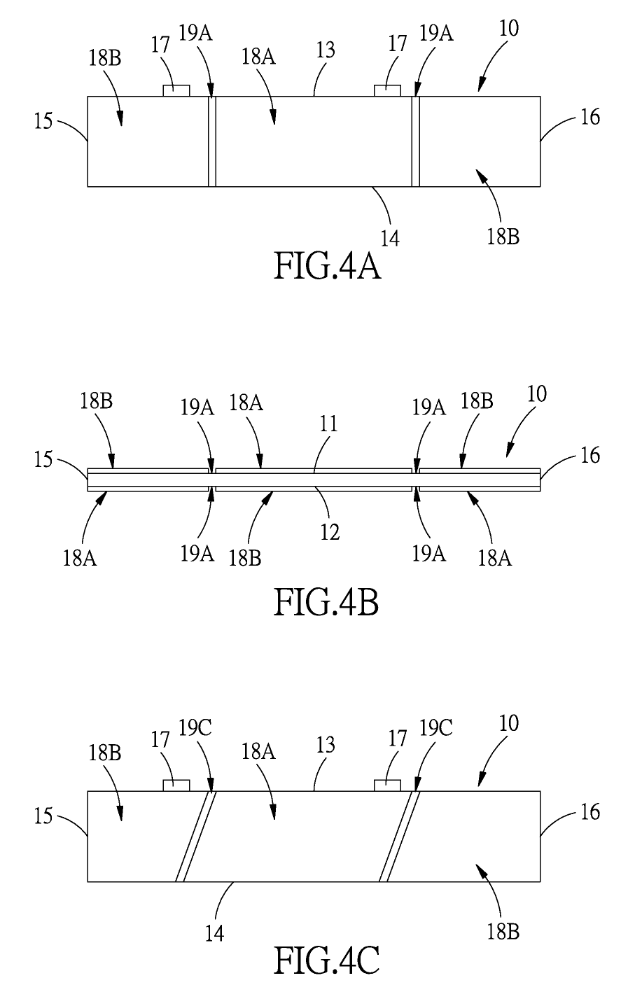

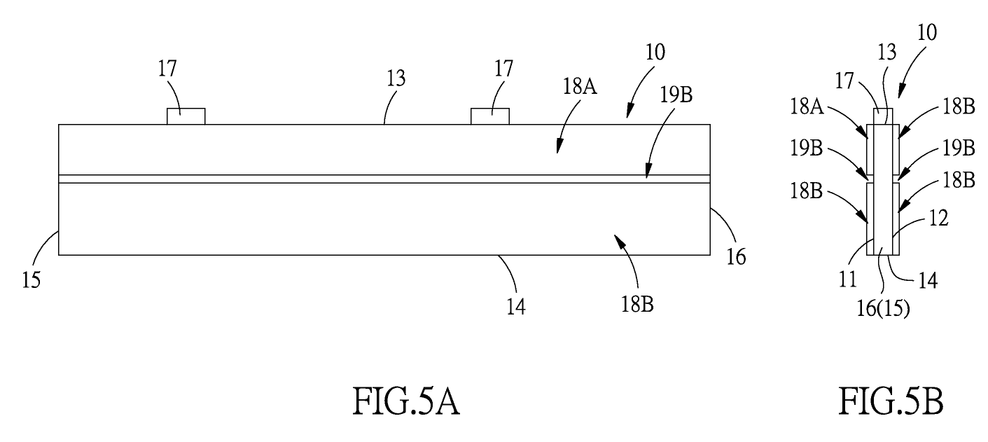

For easy explanation of the coating process, the coating section coated with the LNCA or LNCM is defined as a coating section 18A, and the coating section coated with LFP is define as a coating section 18B. The non-coating section 19 is in the shape of an elongated strip arranged in a longitudinal, transverse or inclined manner to divide the coating area of the positive electrode layer 10 into a plurality of coating sections 18. For example, as shown in FIG. 3A, the non-coating section perpendicularly connected between the two opposite lateral edges 13, 14 of the positive electrode layer 10 is defined as a longitudinal non-coating section 19A; as shown in FIG. 5B, the non-coating section perpendicularly connected between the two opposite inner and outer ends of the positive electrode layer 10 is defined as a transverse non-coating section 19B; and as shown in FIG. 4C, the non-coating section connected between the two opposite lateral edges 13, 14 in an inclined manner is defined as an inclined non-coating section 19C.

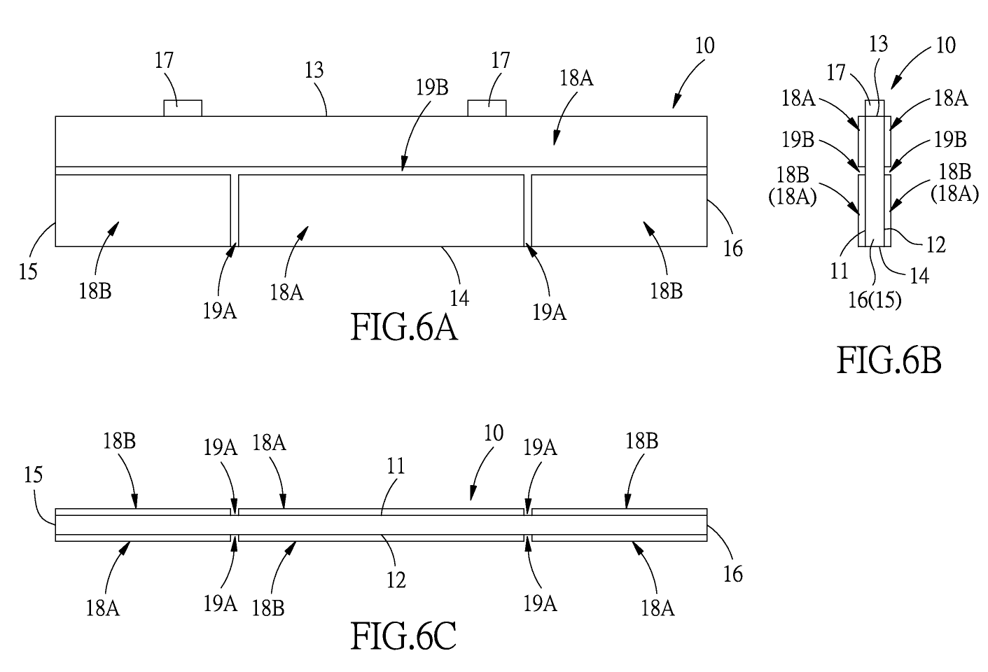

It is to be noted that the aforementioned phrase “perpendicular” means approximately perpendicular or exactly perpendicular, “perpendicularly connected” and “connected” refers to how the non-coating section extends and is connected, as shown in FIG. 6A. The above phrases are used to describe the arrangement status of the non-coating section, but not for limitation purpose. Besides, the size and the thickness of the positive electrode layer 10 shown in drawings are used to illustrate the condition of the coating only, but not intended to explain or limit the technology of the present invention.

### Embodiment 1

As shown in FIGS. 3A and 3B, the coating area of the positive electrode layer 10 includes, in sequence from the inner end 15 to the outer end 16, a coating section 18A, a longitudinal non-coating section 19A and a coating section 18B. The two coating sections 18A, B are coated with lithium containing ternary oxide and LFP, respectively. The two opposite surfaces 11, 12 of the positive electrode layer 10 are each provided with a coating section 18A, a longitudinal non-coating section 19A and a coating section 18B, and the coating sections 18A, the longitudinal non-coating sections 19A and the coating sections 18B on the two opposite surfaces 11, 12 are located corresponding or in alignment to each other, and the positive electrode materials coated thereon are also corresponding to each other, which means that the positive electrode material applied to the coating section 18A on the surface 11 is the same as the positive electrode material applied to the coating section 18A on the surface 12, and the positive electrode material applied to the coating section 18B on the surface 11 is the same as the positive electrode material applied to the coating section 18B on the surface 12. In this embodiment, under the precondition that the locations of the coating sections on the two opposite surfaces 11, 12 are corresponding to each other, the area proportion of the coating section 18A to the coating section 18B can be adjusted based on the design requirement of the battery, or the area proportion can also be adjusted by coating the coating sections 18 with same or different positive electrode materials.

With the aforementioned arrangement of the coating sections and the positive electrode materials, the composite lithium secondary battery of the present invention, at the initial stage of the discharging process, shows the characteristic of lithium containing ternary oxide, namely, provides a relatively high working voltage, and shows the characteristics of lithium containing ternary oxide and LFP during the discharging process, namely, relatively high capacitance, safety and excellent deep discharger recovery, providing a lithium secondary battery with the advantages of lithium containing ternary oxide and LFP.

### Embodiment 2

As shown in FIGS. 4A and 4B, the coating area of the positive electrode layer 10 includes, in sequence from the inner end 15 to the outer end 16, two longitudinal non-coating sections 19A and three coating sections separated from one another by the two longitudinal non-coating sections 19A. The corresponding coating sections on the two opposite surfaces 11, 12 of the positive electrode layer 10 are coated with different positive electrode materials. For example, as shown in FIG. 4B, the surface 11 is provided with a coating section 18B, a coating section 18A, and a coating section 18B which are coated with LFP, lithium containing ternary oxide and LFP, respectively. The surface 12 is provided with a coating section 18A, a coating section 18B, and a coating section 18A which are coated with lithium containing ternary oxide, LFP and lithium containing ternary oxide, respectively. In this embodiment, the area proportion of the three coating sections can be adjusted based on the design requirement of the battery, and the location where the positive electrode material is coated can also be adjusted.

As shown in FIG. 4C, the non-coating section has been changed from the longitudinal non-coating section 19A as shown in FIG. 4A to the inclined non-coating section 19C. The inclined non-coating section 19C can also be connected between the inner and outer ends 15, 16 of the positive electrode layer 10.

### Embodiment 3

As shown in FIGS. 5A and 5B, the coating area of the positive electrode layer 10 includes two transverse non-coating sections 19B and two coating sections separated from one another by the two transverse non-coating sections 19B. The corresponding coating sections on the two opposite surfaces 11, 12 of the positive electrode layer 10 are coated with different positive electrode materials. For example, as shown in FIG. 5B, the surface 11 is provided, in sequence from the lateral edge 13 to the lateral edge 14, with a coating section 18A and a coating section 18B which are coated with lithium containing ternary oxide and LFP, respectively. The surface 12 is provided with a coating section 18B, and a coating section 18b which are both coated with LFP. In this embodiment, the area proportion of the three coating sections can be adjusted based on the design requirement of the battery, and the location where the positive electrode material is coated can also be adjusted. Besides, the two coating sections on the surface 12 are coated with the same positive electrode material, so that the transverse non-coating section 19B on the surface 12 can be deleted to simplify the coating procedure.

### Embodiment 4

As shown in FIGS. 6A, 6B and 6C, on the surfaces 11, 12 are provided a transverse non-coating section 19B and two longitudinal non-coating section 19A which are connected between the transverse non-coating section 19B and the lateral edge 14, so as to divide the coating area into four coating sections, three on the top and one at the bottom. The corresponding coating sections on the two opposite surfaces 11, 12 of the positive electrode layer 10 are coated with different positive electrode materials. For example, as shown in FIGS. 6B and 6C, the surface 11 is provided with a coating section 18A which is located adjacent to the positive electrode ear 17, and the rest three coating sections are coating section 18B, 18A and 18B which are sequentially arranged from the inner end 15 to the outer end 16. The surface 12 is provided with a coating section 18A which is located adjacent to the positive electrode ear 17, and the rest three coating sections are coating section 18A, 18B and 18B which are arranged in order from the inner end 15 to the outer end 16. In this embodiment, the area proportion of the three coating sections can be adjusted based on the design requirement of the battery, and the location where the positive electrode material is coated can also be adjusted.

It should be understood that the coating of the positive electrode material is not limited to the abovementioned embodiments, but can be adjusted as desired, as long as the arrangement of the coating sections and the positive electrode materials can improve the work efficiency of the lithium secondary battery.

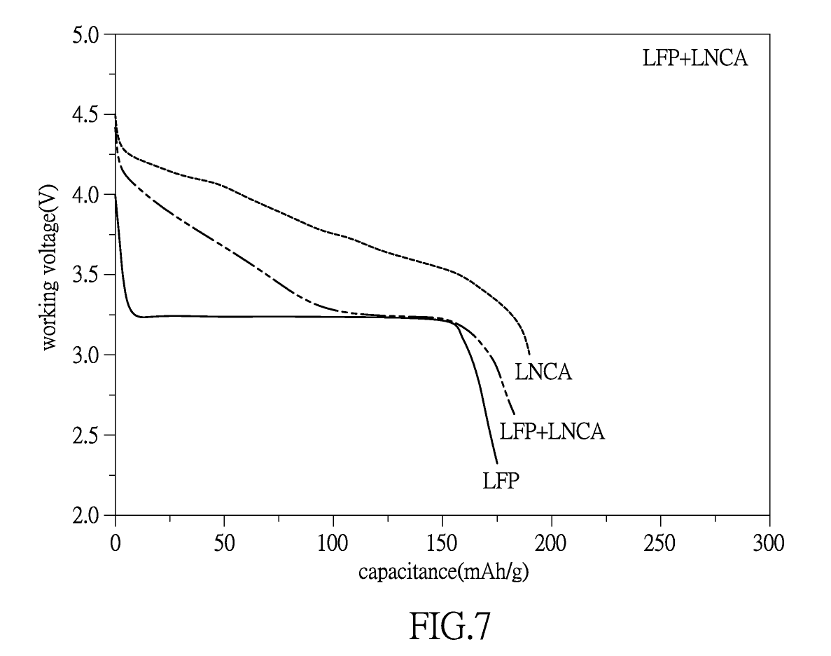

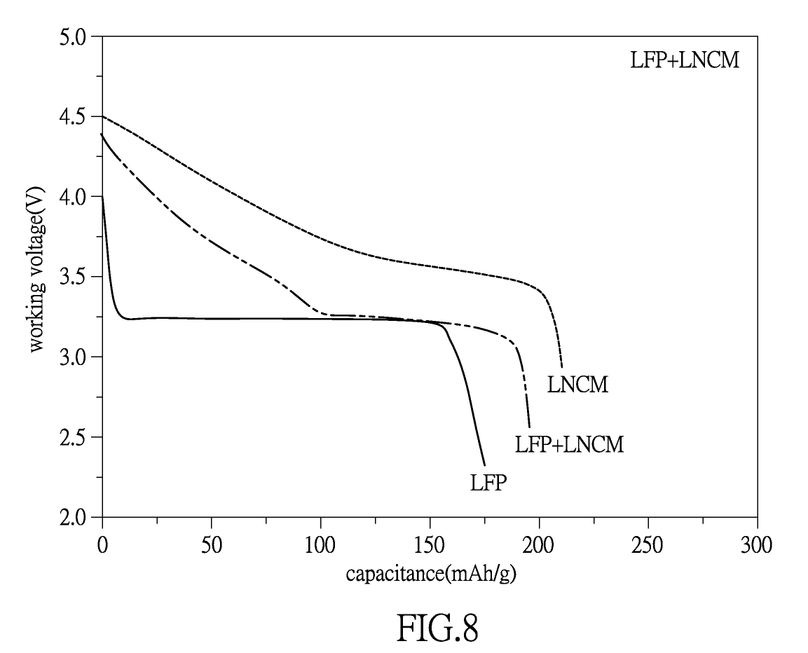

FIGS. 7 and 8 show characteristic curves of the composite lithium secondary battery of the present invention and the conventional lithium secondary battery coated with a single positive electrode material.

FIG. 7 is LNCA curve and FIG. 8 is LNCM curve, which respectively show the discharge characteristic of two ternary positive electrode materials, LNCA and LNCM. The ternary positive electrode material has the advantages of high working voltage and high energy density, the working voltage ranges from 3.2 V to 4.5 V (normally 3.7), capacitance is 17 to 190 mAh/g. However, the ternary positive electrode material has a relatively high discharge closing voltage of 3V to 2.7 V. in case of over discharge (discharge is performed when voltage is lower than 3.0V), overly intercalated lithium ions will permanently stay in the lattice and cannot be released, which will reduce the battery life.

The LFP curves of FIGS. 7 and 8 show the discharge characteristics of the LFP, wherein LFP is worse than the aforementioned ternary positive electrode materials in respect of working voltage and energy density, and has a working voltage of 2.5V to 3.8 V (normally 3.2), and a capacitance of 130 to 150 mAh/g. However, the discharge closing voltage of the LFP can be as low as 2V, which is obviously lower than the ternary positive electrode materials, and has an excellent over discharge recovery.

Different positive electrode materials, such as the combination of LFP+LNCA (as shown in FIG. 7), or LFP+LNCM (as shown in FIG. 8), are coated in different coating sections of the same positive electrode, so as to form a composite lithium secondary battery. The aforementioned positive electrode materials are combined and tested to obtain the curve of LFP+LNCA as shown in FIG. 7, and the curve of LFP+LNCM as shown in FIG. 8, which respectively represent the discharge characteristics of the LFP+LNCM composite lithium secondary battery and the LFP+LNCA composite lithium secondary battery.

It can be learned from the LFP+LNCA curve of FIG. 7 that the working voltage of the composite lithium secondary battery with LNCA positive electrode material in the initial discharge stage is obviously higher than the composite lithium secondary battery with LFP positive electrode material, the working voltage decreases smoothly instead of rapidly, and the performance of the working voltage and the capacitance at the initial stage is similar to the LFP+LNCA curve. At the later discharge stage, the LFP positive electrode material makes the working voltage of the composite lithium secondary battery close to the LFP curve, however, the discharge closing voltage has reached as low as 2.6 V, which is much lower than and beyond the discharge closing voltage range of the LNCA curve. The curves show that the composite lithium secondary battery with LFP+LNCA has a working voltage ranging from 4.5V to 2.7 V, and a capacitance over 175 mAh/g. Therefore, the composite lithium secondary battery of the present invention has the advantages of high working voltage, high capacitance, resistant to deep charge and excellent over discharge recovery.

It can be learned from the LFP+LNCM curve of FIG. 8 that the working voltage of the composite lithium secondary battery with LNCM positive electrode material in the initial discharge stage is obviously higher than the composite lithium secondary battery with LFP positive electrode material, the working voltage decreases smoothly instead of rapidly, and the performance of the working voltage and the capacitance at the initial stage is similar to the LFP+LNCM curve. At the later discharge stage, the LFP positive electrode material makes the working voltage of the composite lithium secondary battery close to the LFP curve, however, the discharge closing voltage has reached as low as 2.5 V, which is much lower than and beyond the discharge closing voltage range of the LNCA curve. The curves show that the composite lithium secondary battery with LFP+LNCM has a working voltage ranging from 4.4V to 2.6 V, and a capacitance over 185 mAh/g. Therefore, the composite lithium secondary battery of the present invention has the advantages of high working voltage, high capacitance, resistant to deep charge and excellent over discharge recovery.

While we have shown and described various embodiments in accordance with the present invention, it is clear to those skilled in the art that further embodiments may be made without departing from the scope of the present invention.

What is claimed is:

1. A composite lithium secondary battery comprising a core assembly, and the core assembly comprising: at least one positive electrode layer, at least one negative electrode layer and a plurality of separating layers disposed between the positive and negative electrode layers, wherein the positive and negative electrode layers and the separating layer are superimposed one another and then roll up to form the core assembly, the positive electrode layer being provided with positive electrode materials which allow for intercalation and deintercalation of an electrode reaction material, at least one positive electrode ear being provided at a lateral edge of the positive electrode layer, two opposite surfaces of the positive electrode layer being provided with the positive electrode materials, when the positive electrode layer rolls up into a coil, one of two opposite ends of the positive electrode layer which is located in a center of the coil is defined as an inner end, and another of the two opposite ends is defined as an outer end, the negative electrode layer being provided with negative electrode materials which allow for intercalation and deintercalation of the electrode reaction material, at least one negative electrode ear being provided at a lateral edge of the negative electrode layer; the composite lithium secondary battery being characterized in that:
each of the two opposite surfaces of the positive electrode layer is provided with a plurality of coating sections and at least one non-coating section, each of the coating sections is coated with one of the positive electrode materials, and the positive electrode materials coated on the two opposite surfaces of the positive electrode layer are located in alignment with each other, the coating sections and the positive electrode materials coated thereon are separated from one another by the non-coating section, a width of the non-coating section is larger than or equal to 0.5 mm, at least one said coating section on each of the two opposite surfaces of the positive electrode layer is coated with a different positive electrode material than other coating sections, the positive electrode materials include a combination of LiFePO₄ and lithium-containing ternary oxide.

2. The composite lithium secondary battery as claimed in claim 1, wherein the lithium-containing ternary oxide is selected from the group consisting of LiNiₓCoyAl_{1-x-y}O₂ or LiNiCoMnO₂.

3. The composite lithium secondary battery as claimed in claim 1, wherein the positive electrode materials include a combination of LiFePO₄ and LiNiₓCoyAl_{1-x-y}O₂.

4. The composite lithium secondary battery as claimed in claim 3 having a working voltage ranging from 4.5 V to 2.7 V, and a capacitance over 175 mAh/g.

5. The composite lithium secondary battery as claimed in claim 2, wherein the positive electrode materials include LiFePO₄ and LiNiₓCoyAl_{1-x-y}O₂.

6. The composite lithium secondary battery as claimed in claim 5, wherein the composite lithium secondary battery has a working voltage ranging from 4.5 V to 2.7 V, and a capacitance over 175 mAh/g.

7. The composite lithium secondary battery as claimed in claim 1, wherein the positive electrode materials include LiFePO₄ and LiNiCoMnO₂.

8. The composite lithium secondary battery as claimed in claim 7, wherein the composite lithium secondary battery has a working voltage ranging from 4.4 V to 2.6 V, and a capacitance over 185 mAh/g.

9. The composite lithium secondary battery as claimed in claim 2, wherein the positive electrode materials of the composite lithium secondary battery include LiFePO₄ and LiNiCoMnO₂.

10. The composite lithium secondary battery as claimed in claim 9, wherein the composite lithium secondary battery has a working voltage ranging from 4.4 V to 2.6 V, and a capacitance over 185 mAh/g.

11. The composite lithium secondary battery as claimed in claim 1, wherein the width of the non-coating section is smaller than 5 cm and larger than 0.5 mm.

12. The composite lithium secondary battery as claimed in claim 1, wherein the negative electrode materials include carbon materials of graphite or coke.

13. The composite lithium secondary battery as claimed in claim 1, wherein one of the coating sections which is closest to the outer end of the positive electrode layer is LiFePO₄.

14. The composite lithium secondary battery as claimed in claim 1, wherein the non-coating section includes a longitudinal non-coating section connected between two opposite lateral edges of the positive electrode layer, a transverse non-coating section connected between the inner and outer ends of the positive electrode layer, and an inclined non-coating section connected between the two opposite lateral edges or the inner and outer ends in an inclined manner, the longitudinal non-coating section, the transverse non-coating section or the inclined non-coating section is formed on each of the two opposite surfaces to divide the two opposite surfaces of the positive electrode layer into the coating sections.
